(19) United States
(12) Patent Application Publication
(10) Pub. No.: US 2025/0307848 A1
(43) Pub. Date: Oct. 2, 2025

(54) SYSTEMS AND METHODS FOR ADAPTIVE API RULE MANAGEMENT

(71) Applicant: Quartile Digital, Inc., New York, NY (US)

(72) Inventors: Daniel Knijnik, Riverside, CT (US); Anibal Knijnik, Aventura, FL (US); Alexandre Dorbleo Ely, Botucatu (BR); Rodrigo Fraga Mohr, Porto Alegre (BR); Solano Pertile Campos, Porto Alegre (BR); Douglas Torgo Fabretti, Capao da Canoa (BR)

(21) Appl. No.: 19/096,948

(22) Filed: Apr. 1, 2025

Related U.S. Application Data
(60) Provisional application No. 63/572,515, filed on Apr. 1, 2024.

(51) Int. Cl. G06Q 30/0201; G06F 9/54; G06F 16/9535

(52) U.S. Cl. CPC G06Q 30/0201; G06F 9/547; G06F 16/9535

(57) ABSTRACT

A method and associated system for retrieving data associated with an online marketplace, including determining, based on a search of a configuration table, a configuration associated with an online marketplace channel API; determining, based on a search of a customer query table, one or more customers requiring data retrieval; generating one or more required time periods for data retrieval based in part on one or more settings of the configuration associated with the online marketplace channel API; dividing, based on the one or more settings of the configuration associated with the online marketplace channel API, the one or more required time periods into a plurality of time subperiods compliant with the online marketplace channel API; retrieving data from the online marketplace channel API in batches based on the plurality of time subperiods compliant with the online marketplace channel API; and storing the retrieved data.

### CROSS-REFERENCE TO RELATED APPLICATIONS

The present application claims priority to U.S. Provisional Patent Application No. 63/572,515, filed Apr. 1, 2024, the disclosures and teachings of which are incorporated herein by reference.

### TECHNICAL FIELD

The present invention relates to systems and methods for optimizing the time spent in gathering and storing information from e-commerce marketplaces through application programming interfaces (APIs), particularly systems and methods for adaptive API rule management, optimizing development efficiency and ensuring data reliability across diverse marketplace systems.

### BACKGROUND OF THE INVENTION

In today's highly competitive business landscape, gathering data from different marketplaces is crucial for companies to make informed decisions and gain a competitive edge. APIs have simplified the process of accessing marketplace data. However, optimizing the time spent gathering data from multiple marketplaces via API presents its own set of challenges.

One of the primary challenges in optimizing the time spent gathering data from different marketplaces via API is the need to work with multiple APIs. Each marketplace typically has its own API with varying documentation, data structures, authentication methods, and rate limits. Navigating through the intricacies of multiple APIs consumes significant time and effort. For example, making changes in an API for one marketplace may demand up to 250% more programming time than making roughly the same number of changes in an API for another marketplace.

Marketplaces often have unique data structures and formats, making it challenging to ensure data consistency and standardization across different platforms. Each marketplace may use different naming conventions, categorization schemes, and attribute formats, leading to discrepancies and inconsistencies in the gathered data. Aligning and normalizing the data from various marketplaces is a time-consuming task, demanding a large amount of labor and development time.

An example of the difficulties caused by this complex environment is the need for a digital marketing company (DMC) to handle different rules regarding how to access each of those APIs. DMCs depend on getting timely information from the various marketplaces their clients use to sell their goods. Each and every modification of the API access rules and/or methods from one marketplace to the next requires time-intensive programming and debugging efforts from the DMC as the DMC adjusts its own processes for a particular marketplace. For example, some marketplaces may establish a limit of 1000 requests per minute, some may specify a limit of 10 requests per hour, and some may set the limit on 100 requests per day. The DMC needs to access each of these marketplaces and adjust their processes to match the rules of the APIs for each marketplace. These adjustments are costly and usually cause a delay in the flux of information to the clients.

To optimize the time and effort spent on retrieved and stored data consistency and standardization, companies may establish a solid and trustful data governance framework. This framework may define consistent naming conventions, categorization standards, and data models that can be applied across different marketplaces. By investing in automated data transformation and mapping tools, companies may look for automated ways to speed up aligning and standardizing the concepts around the data acquisition process, ensuring consistency, and reducing manual effort.

In addition to that, each marketplace has different update frequencies for their data. Some marketplaces provide real-time or near-real-time data updates, while others may have delayed updates or batch processing schedules. Dealing with these varied update frequencies poses a big challenge in ensuring timely access to the most current data from different marketplaces, information that is of paramount importance for the planning and implementation of marketing actions by and for the clients of DMCs.

To optimize time spent on data updates, companies may prioritize their data requirements and align them with the update frequencies of each marketplace. By understanding the update schedules of different marketplaces, companies can schedule data-gathering processes accordingly. Leveraging technologies such as event-driven architectures or leveraging webhooks can help streamline the process of capturing real-time data updates, reducing time delays. To illustrate how update frequencies vary from one channel to another, it may be a practice in Channel A for all reports from the previous day to be ready as soon as midnight the next day, while Channel B may have that data available only after 10 AM the next day.

As companies gather data from multiple marketplaces via API, scalability and performance challenges may arise. Handling large volumes of data and managing concurrent API requests can impact the speed and efficiency of the data-gathering process. Additionally, fluctuations in marketplace traffic and varying API response times can further hinder the optimization of data-gathering time.

To address scalability and performance challenges, companies must rely on scalable data processing frameworks. Leveraging distributed computing and parallel processing techniques optimizes the handling of large data volumes and contributes to improving the overall performance of the DMCs. Caching mechanisms and intelligent request management strategies are needed to optimize an API's request handling and minimize latency. Implementing monitoring and alerting systems can also help identify and address performance bottlenecks proactively.

When gathering data from multiple marketplaces, DMCs must ensure the security and compliance of the data handling processes. Marketplaces may have different security protocols, authentication mechanisms, and data usage policies, which companies need to adhere to. Ensuring data privacy, protecting sensitive information, and complying with regulatory requirements across different marketplaces requires the implementation of robust data security measures and leverage standardized authentication protocols consuming additional time and resources.

There is a need in the art for an efficient data-gathering framework, with automated data-gathering via APIs from different marketplaces that empowers companies to make timely, data-driven decisions and gain a competitive advantage in the marketplace.

The present invention solves the problems of the prior art by providing systems and methods for adaptive API rule management, optimizing development efficiency, and ensuring data reliability across diverse marketplace systems.

### SUMMARY OF THE INVENTION

In general, in one aspect, the invention features a method for retrieving data associated with an online marketplace, including, under control of one or more processors configured with executable instructions, determining, based on a search of a configuration table, a configuration associated with an online marketplace channel API, the configuration table including one or more data fields for one or more online marketplace channel current or updated APIs; determining, based on a search of a customer query table, one or more customers requiring data retrieval; generating one or more required time periods for data retrieval based in part on one or more settings of the configuration associated with the online marketplace channel API; dividing, based on the one or more settings of the configuration associated with the online marketplace channel API, the one or more required time periods into a plurality of time subperiods compliant with the online marketplace channel API; retrieving data from the online marketplace channel API in batches based on the plurality of time subperiods compliant with the online marketplace channel API; and storing the retrieved data.

Implementations of the invention may include one or more of the following features. The one or more data fields for one or more online marketplace channel current or updated APIs may be one or more of a channel name, a data ingestion call alias, a listing of all fields of data extracted from an online marketplace channel API endpoint, a local storage location, an SQL query listing of customers to be processed for data retrieval, a duration for data retrieval, and a data retrieval speed and, more specifically, the one or more data fields for one or more online marketplace channel current or updated APIs may include a channel name, a data ingestion call alias, and a local storage location. Generating one or more required time periods for data retrieval may include retrieving a full data history and a partial data history for establishing configuration settings. The configuration settings may include a period name, a period start date, a period end date, and a number of dates between the period start date and the period end date.

The method may further include storing an execution log of all data retrievals. The execution log may include metrics relating to all data retrievals, the metrics including one or more of a percentage of data retrieval successes, a percentage of data retrieval failures, a number of data retrieval executions, a percentage of errors, and a data retrieval duration. The errors in the percentage of errors may include authentication errors, unknown errors, throttling errors, token service expiration errors, and timeout errors. The execution log may be displayed on a single centralized dashboard. The retrieved data may be stored in a local infrastructure of a digital marketing company.

In general, in another aspect, the invention features a system for retrieving data associated with an online marketplace, including one or more processors, one or more computer-readable media, and one or more modules maintained on the one or more computer-readable media that, when executed by the one or more processors, cause the one or more processors to perform operations including determining, based on a search of a configuration table, a configuration associated with an online marketplace channel API, the configuration table including one or more data fields for one or more online marketplace channel current or updated APIs; determining, based on a search of a customer query table, one or more customers requiring data retrieval; generating one or more required time periods for data retrieval based in part on one or more settings of the configuration associated with the online marketplace channel API; dividing, based on the one or more settings of the configuration associated with the online marketplace channel API, the one or more required time periods into a plurality of time subperiods compliant with the online marketplace channel API; retrieving data from the online marketplace channel API in batches based on the plurality of time subperiods compliant with the online marketplace channel API; and storing the retrieved data.

Implementations of the invention may include one or more of the following features. The one or more data fields for one or more online marketplace channel current or updated APIs may be one or more of a channel name, a data ingestion call alias, a listing of all fields of data extracted from an online marketplace channel API endpoint, a local storage location, an SQL query listing of customers to be processed for data retrieval, a duration for data retrieval, and a data retrieval speed and, more specifically, the one or more data fields for one or more online marketplace channel current or updated APIs may include a channel name, a data ingestion call alias, and a local storage location. Generating one or more required time periods for data retrieval may include retrieving a full data history a and partial data history for establishing configuration settings. The configuration settings may include a period name, a period start date, a period end date, and a number of dates between the period start date and the period end date.

The system may further include an additional operation of storing an execution log of all data retrievals. The execution log may include metrics relating to all data retrievals, the metrics including one or more of a percentage of data retrieval successes, a percentage of data retrieval failures, a number of data retrieval executions, a percentage of errors, and a data retrieval duration. The errors in the percentage of errors may include authentication errors, unknown errors, throttling errors, token service expiration errors, and timeout errors. The execution log may be displayed on a single centralized dashboard. The retrieved data may be stored in a local infrastructure of a digital marketing company.

### BRIEF DESCRIPTION OF THE DRAWINGS

FIG. 1 shows a first segment of a schematic flowchart for a data-gathering process of the present invention;

FIG. 2 shows a second segment of the schematic flowchart from FIG. 1 for the data-gathering process of the present invention;

FIG. 3 shows a first sub-process of the schematic flowchart from FIG. 1 for the data-gathering process of the present invention;

FIG. 4 shows a second sub-process of the schematic flowchart of FIG. 1 for the data-gathering process of the present invention;

FIG. 5 shows a third process of the schematic flowchart of FIG. 2 for the data-gathering process of the present invention;

FIG. 6 shows a fourth sub-process of the schematic flowchart of FIG. 2 for the data-gathering process of the present invention;

FIG. 7 shows a first application of the data-gathering process of the present invention;

FIG. 8 shows metrics utilized in the first application of the data-gathering process of the present invention;

FIG. 9 shows an enlarged view of a first portion of the first application of FIG. 7 for the data-gathering process of the present invention;

FIG. 10 shows an enlarged view of a second portion of the first application of FIG. 7 for the data-gathering process of the present invention;

FIG. 11 shows a second application of the data-gathering process of the present invention;

FIG. 12 shows a splitting process for the second application of FIG. 11 for the data-gathering process of the present invention;

FIG. 13 shows a tabular representation of data provided by the second application of FIG. 11 for the data-gathering process of the present invention;

FIG. 14 shows a third application of the data-gathering process of the present invention;

FIG. 15 show a fourth application of the data-gathering process of the present invention;

FIG. 16 shows a fifth application of the data-gathering process of the present invention;

FIG. 17 shows an enlarged view of the highlighted portion of FIG. 16;

FIG. 18 shows a sixth application of the data-gathering process of the present invention;

FIG. 19 shows an enlarged view of the highlighted portion of FIG. 18;

FIG. 20 shows a tabular representation of overall successes and failures for the sixth application of the data-gathering process of the present invention;

FIG. 21 shows exemplary channels utilized in connection with a data-gathering process of the present invention;

FIG. 22 shows an output concerning errors encountered in a data-gathering process of the present invention;

FIG. 23 shows a graphical representation of an average duration of a data-gathering process of the present invention; and

FIG. 24 shows a tabular result of an average duration of a data-gathering process of the present invention according to FIG. 23.

### DETAILED DESCRIPTION OF THE INVENTION

The present t invention is directed to optimizing the gathering of data from different marketplaces through a system characterized as a data-gathering framework (herein referred to as the “Data-Gathering Framework” or “Framework”). The present invention is primarily aimed at reducing the time and the cost of collecting data efficiently while respecting the ever-changing rules and parameters imposed by each marketplace upon their APIs.

The Data-Gathering Framework is a standardized process developed to collect data from different marketplace channels' APIs in a consistent and structured manner. The Framework provides a storage of channel configurations, maintenance of execution logs, return of standard output, and control of pipeline and flow. The Framework is updated continuously based on every new channel's requirement to provide additional functionalities. A user of the present invention, e.g., the intelligence team of a DMC, may use the Framework to gather data from different channels including, but not limited to, INSTACART, AMAZON, FACEBOOK, GOOGLE, BING, WALMART, and SHOPIFY.

The Framework helps the DMCs to collect data efficiently, in a reduced time, at a lower cost, and with better quality. To control the execution of the gathering process, the present invention may include a dashboard. The dashboard allows a user, e.g., the intelligence team of the DMC, to monitor the efficiency of the data-gathering process in almost real time.

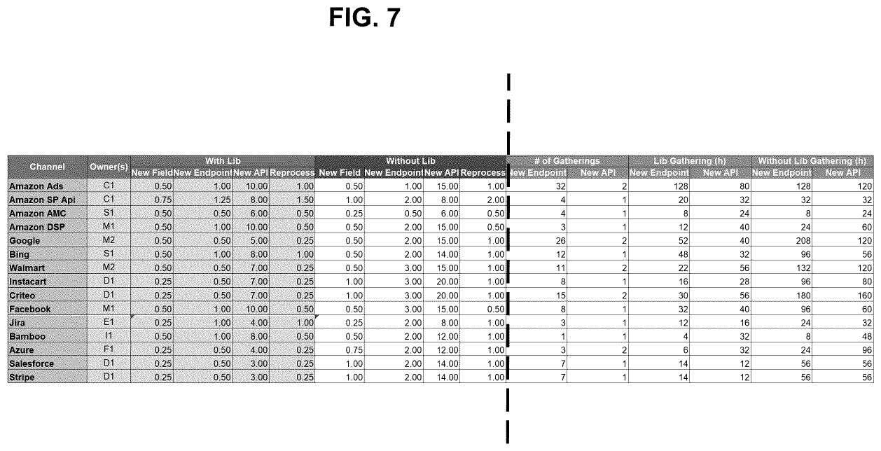

The Framework is constantly updating such that it complies with the requirements of all channels. Thus, if a new functionality that is not currently supported by the Framework is spotted and the new functionality is believed to be beneficial, the Framework may be adapted to support the new functionality in very little time. In one of the embodiments of the present invention, as best seen in FIG. 7, the Framework reduces the time to adapt the data-gathering to new requirements of a marketplace by 54%.

The object of the present invention is to create a new software application that optimizes the retrieval and storage of large quantities of data from a variety of marketplaces' APIs, where the present invention is adaptable to a multitude of new channels, endpoints, and rules imposed by a marketplace on the API. The present invention manages and orchestrates any new task (or modification) imposed by marketplaces' API environments for the retrieval of the desired data.

The present invention may be divided into three processes: (1) data ingestion; (2) checking the reliability of the data ingested; and (3) storage of the data in the appropriate places in the organization database (internal or external). One point of novelty of the present invention resides in the first process, data ingestion.

For purposes of explanation, the process of data ingestion may be further divided into smaller actions that must be taken to make the data available to a DMC.

Generally, the process of data ingestion involves extracting, i.e., retrieving, data from a channel and making it available for storage, or immediate use, by a user, e.g., the IT team of a DMC. In one of the embodiments of the present invention, this retrieved data is stored in the Microsoft Azure cloud infrastructure.

Data ingestion becomes more complicated when faced with the limitations imposed by different marketplaces, which can change freely at a given marketplace's will. To tackle this environment, one must start by listing all the attributes of the desired variables and the actual boundaries and limits imposed by the marketplaces and insert them in a Configuration Table (“Config Table”). The data inserted in the Config Table must match the logic and requirements of a channel's API.

In one embodiment of the present invention, the Config Table includes the following data fields for the API/channel pair, some of them are optional depending on configuration needs of each channel:
1. Channel
2. Object_name
3. Selected_fields
4. Folder_path
5. Accounts_query
6. Partial_history_window
7. Full_history_window
8. Parallelism_limit

The “Channel” data field is the name of the channel being used, e.g., AMAZON, WALMART, etc.

The “Object_name” data field is the alias for naming the data ingestion calls, e.g., campaign_report.

The “Selected_fields” data field is a list with all fields of data that will be extracted from the given channel's API endpoint, e.g., campaign_id, campaign_name, date, revenue, cost, clicks, views, etc.

The “Folder_path” data field states the location where data will be stored inside a DMC's infrastructure, e.g., /mnt/raw/amazon/campaign/.

The “Accounts_query” data field is the SQL query that lists which clients need the data-gathering process executed, e.g., all WALMART Sellers retrieved from WALMART's internal database.

The “Partial_history_window” data field defines how many days of data need to be pulled for all clients, e.g., last 7 days.

The “Full_history_window” data field defines how many days of data need to be pulled for new clients only, e.g., those that joined a DMC recently and need to have their historical data populated (such as the last 5 years).

The “Parallelism_limit” data field dictates how fast the channel allows the DMC to pull data. This functionality deals with the rate limits from the different existing channels' APIs, e.g., 2 requests per second per client.

The above fields need not always be present and, when necessary, other fields can be easily added. The ease of this adaptation to new environments and requirements is a distinct characteristic and advantage of the present invention.

In a preferred embodiment of the present invention, the Config Table includes Channel, Object_name, and Folder_path data fields, with other data fields added as needed to adapt to different channels' APIs.

Once the Config Table is defined, the Framework uses the values stored in the Config Table to orchestrate, i.e., define and implement, the methods and processes of the present invention to decide how the system will handle a data retrieval load, at least including (1) the ratio of requests per time unit, (2) for which clients the process collects data and from which marketplace, (3) how far back the time window pulls data from the marketplace, (4) how the data-gathering is organized and prioritized, (5) where the retrieved data is stored during the process execution, and (6) how the data is checked for consistency and accuracy.

Thus, instead of having to develop the entire orchestration logic for every new channel, every new API, or every new endpoint, the present invention only requires developers change the existing Config Table to adapt the present invention to the new boundary conditions, whether the new conditions include one or more of a new channel, a new API, an updated value in an existing API, or a new endpoint. The present invention enables developers to avoid starting from scratch, requiring that they simply adjust the Config Table by changing or adding the modified parameters and fields.

The ease of retrieving data from marketplaces provided by the present invention may be readily seen in situations such as when a DMC's IT team is faced with the task of dealing with a new client. The decision to process the full history for new clients is made automatically by the Framework, starting by checking into the DMC's storage media if that new client has already been processed before. A full history is only needed if the client has never been processed by the DMC. Before the present invention, one needed to keep configuration tables to store information about which clients have already been processed. The Framework is capable of automatically tracking client processing, thereby almost eliminating the need to keep different configuration tables for each process, which represents another great advantage of this invention. This is achieved by the Framework through the checking of an internal table that stores logs of all executions for all channels in a single location, thus easily seeing which clients have already been processed successfully.

The Framework streamlines the processing of data into several parts by providing a configuration mechanism for defining date ranges. Instead of having to pull 5 years of data at the same time, one can easily break it down into smaller time ranges. In one embodiment of the present invention, the time intervals are defined as 30 days each. Prior to the Framework, each new process being developed would require finding a method to deal with this large time window, creating a lack of consistency and again increasing the development effort to integrate the new API.

Regarding the parallelism limit of each channel, the breaking of the data acquisition process is also done automatically by simply taking into account the number of parallel requests allowed by the channel in the configuration table, which can be updated whenever the corresponding marketplace changes its allowances. The Framework does this by calculating the allowable number of requests (X) that can be fired simultaneously for each client and creating partial batches of X number of requests on each batch for each client, thus respecting the channel-imposed limitations. In known systems, the process for handling a parallelism limit either runs on a more sequential method, which is more time-consuming, or allows the requests to fail and reprocess them again later, causing a loss of time and an increase in operation cost. Another prior art approach for handling a parallelism limit involves the creation of more complex task sequencing mechanisms such as relying on queues to speed up processing, resulting in the need for additional infrastructure. The Framework of the present invention avoids such limitations.

As all data is handled by the Framework, the execution logs are all stored in a single location for all channels, enabling the DMC to have a single dashboard with the performance data for all the data-gatherings done by the Framework. Thus, a user may easily validate the system's operation accuracy on any given time interval. Without the Framework, each user needed to build their own separate dashboards, requiring significant time and work for the unification of the data-gathering system and dashboard.

In one embodiment of the present invention, when a new API, field, channel, or endpoint is added, for a given channel, an embodiment of the data-gathering process of the present invention may include the following steps:
1. Search the Config Table for the configuration of the given channel;
2. Search for the customers that must be processed from the query;
3. Generate the required time periods based on the Config Table settings, partial history, and snapshots, where the step of generating includes retrieving a full history and partial history to establish the configuration settings, which generally include the period name, the start date, the end date, and the aimed number of dates in the interval between the start and end dates;
4. Check that the dates are chronologically fit;
5. Based on the Config settings for the channel, split the total number of days into as many sub-periods as necessary to abide by the channel's rules, e.g., if the total number of days to be retrieved is 16 days and the maximum retrieval number of days per request by the channel is 7 days, create three sub-periods, the first and second with 7 days each, and the third with only two days;
6. Create a Full History retrieval of the time interval, e.g., aggregate the Full History from three sub-periods and three Partial Histories, each one with the individual retrieved sub-periods;
7. If the Full History is already configured in the Framework, search for the client's Full History executions on the Execution Log Table, where all the gathered data may be stored in two layers, e.g., a Bronze Table layer with all the raw retrieved data, and a Silver Table layer with the most recent checked data, and where if data already exists for the client on a common data model (CDM) in the Silver Table layer, it is assumed that the Full History for that client has been already executed;
8. If, in the search for the Full History, any execution is found for one client, that client is filtered out from an execution queue, as that client is already onboarded, such that all the remaining clients on the list are new ones. If any failed execution is found on the execution history, the failed executions are returned to the execution queue to be reprocessed in the channel's corresponding marketplace;
9. To perform the data-gathering from the marketplace, the Framework splits the whole period to be processed in as many periods as necessary to comply with each marketplace's boundary conditions (parallelism, tokens, etc.) as defined in the Framework's Config Settings for that client and for that marketplace, and returns to the Framework the processing order and the batch numbers for each customer period, thereafter storing the processing order and batch number for each customer period into a cache table;
10. Next, the process retrieves the data from the API, following the defined configuration of endpoints, URL, tokens, and other aspects of the collection;
11. Once data has been collected, it is stored in local DMC infrastructure to be consumed by other processes from the company;
12. After performing the data collection via API, the results of each customer execution are stored on a reporting table, which keeps track of each execution of each channel and each customer and calculates the main metrics related to the gathering process, e.g., percentage of success, percentage of failures, number of executions, percentage f errors by categories, time taken by each process, etc.; and
13. These stored results are, in sequence, published in a centralized Dashboard, where the intelligence team of the DMC can check the status of each gathering execution by date.

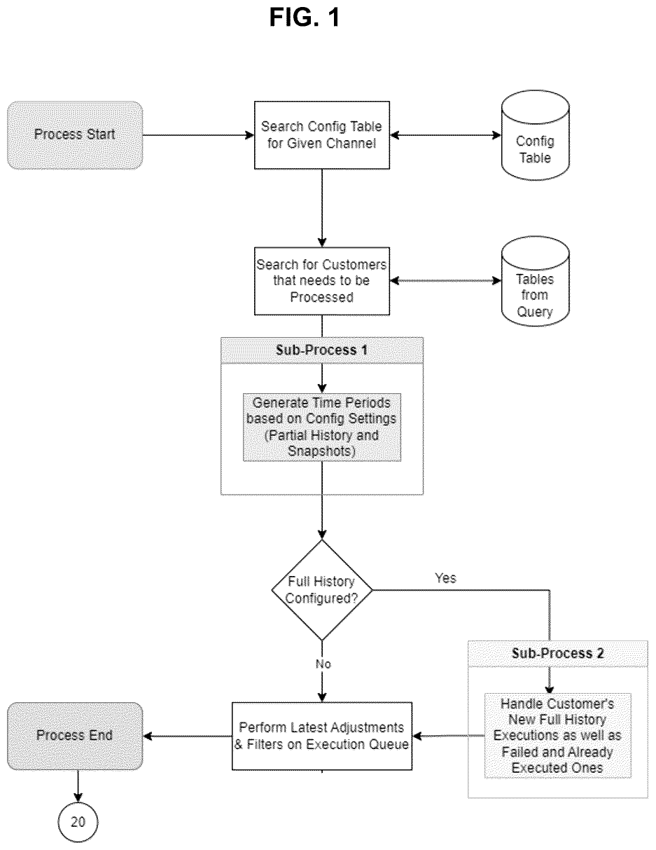

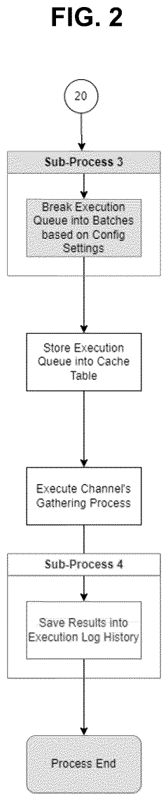

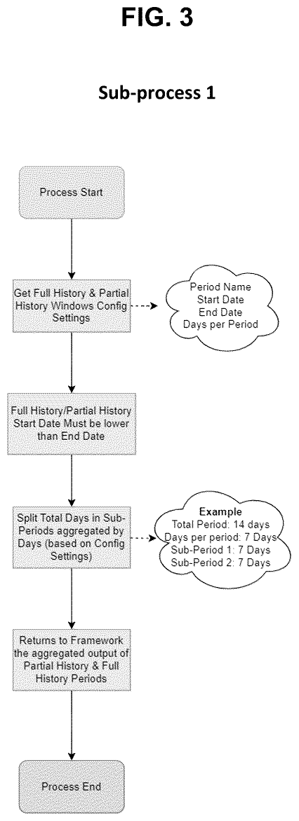

Referring now to the Figures, FIGS. 1 and 2 show a schematic flowchart of the data-gathering process of the present invention. Sub-processes 1, 2, 3, and 4, are highlighted and are detailed in FIGS. 3 to 6. The first portion of data-gathering process shown in FIG. 1 shows the gathering of active customers that need to be processed. The second portion of the data-gathering process shown in FIG. 2 shows the gathering process for running the API calls to interact with the channel.

FIG. 3 shows a detailed schematic flowchart of sub-process 1 seen in FIG. 1. Sub-process 1 details the creation of processing time windows.

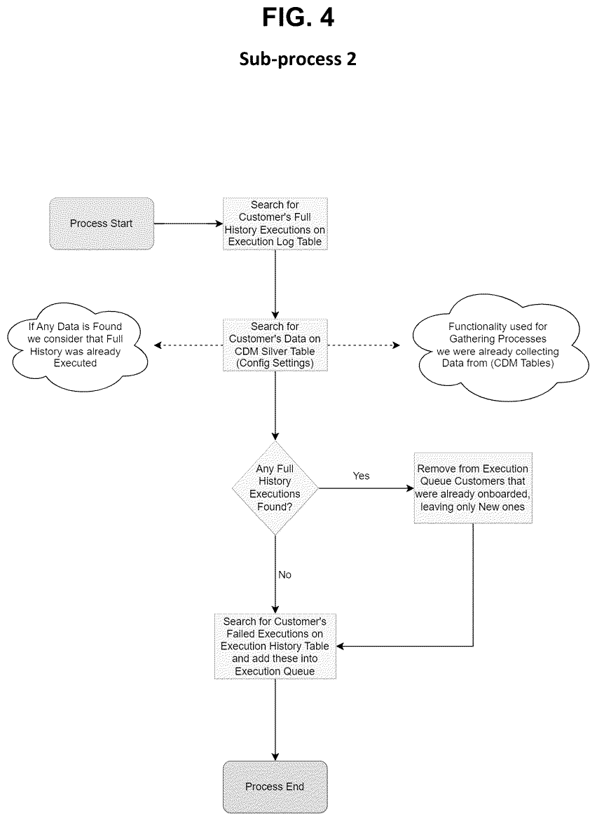

FIG. 4 shows a detailed schematic flowchart of sub-process 2 seen in FIG. 1. Sub-process 2 details the process for identifying new clients.

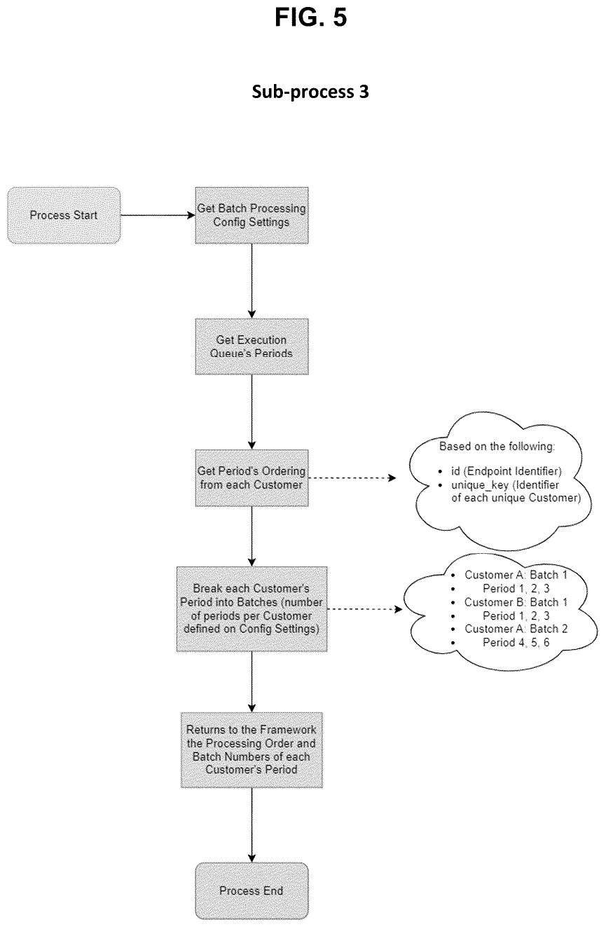

FIG. 5 shows a detailed schematic flowchart of sub-process 3 seen in FIG. 2. Sub-process 3 details the process to break the retrieving activity into batches.

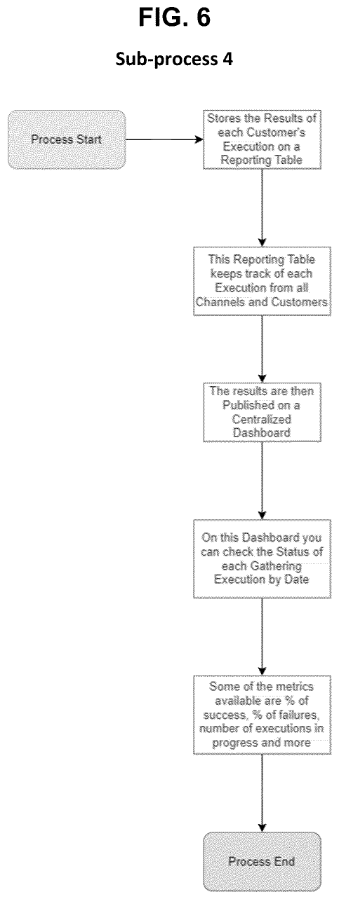

FIG. 6 shows a detailed schematic flowchart of sub-process 4 seen in FIG. 2. Sub-process 4 details the process for out-of-the box reporting.

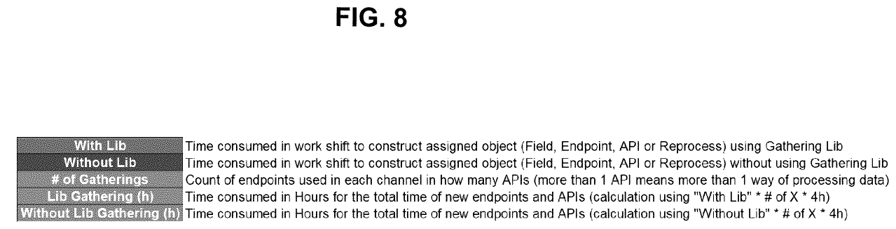

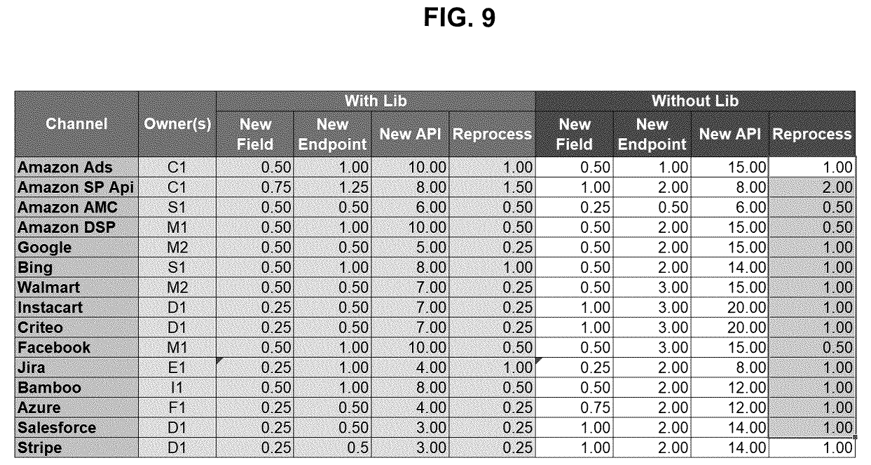

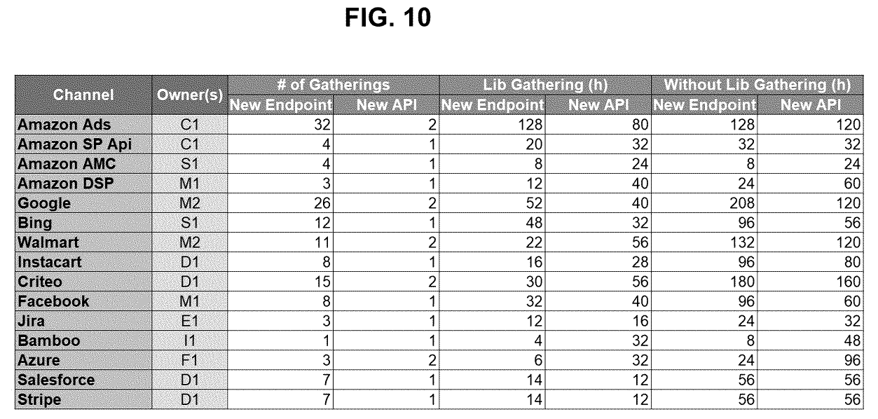

FIG. 7 shows a table with the savings achieved through the implementation of the present invention in one embodiment of this invention. The savings are measured in accordance with metrics shown in FIG. 8. The dotted line in FIG. 7 divides the table, with one portion of the divided table shown enlarged in FIG. 9 and the other portion of the divided table shown enlarged in FIG. 10.

FIG. 8 shows the metrics used to calculate the savings achieved through the use of the present invention. Particularly, the metrics shown in FIG. 8 include: (1) time consumed (in work shifts) to construct an object (Field, Endpoint, API, or Reprocess) using the present invention (shown as with Lib) and without using the present invention (without Lib); and (2) time consumed (in hours) to construct the same object, with (shown as with Lib) and without (shown as without Lib) use of the present invention.

FIG. 9 shows an enlarged view of a first portion of the table seen in FIG. 7. The first portion of the table shows the comparison in work shifts used to construct an object for the gathering of a new Field, Endpoint, API, or Reprocess, both using the present invention (with Lib) and without using the present invention (without Lib). For instance, to construct and object to deal with a new API, the number of work shifts is 10 with the use of the present invention and the number of work shifts is 15 without use of the present invention. When considering a typical workshift is 4 hours, the present invention saves 20 hours of construction time ((15−10)×4 hr=20 hr) per new API.

FIG. 10 shows the number of endpoints retrieved in each channel, through all the necessary APIs. The first line of the table shows that there were retrieved a total of 32 endpoints through 2 APIs. Each API demanded 10 work shifts of 4 hours each using the present invention, consuming 80 hours of labor (10×2×4=80). As each API demanded 15 work shifts without the use of the present invention, the total number of work hours consumed without the present invention is 120 hours (15×2×4=120), representing a total saving of 40 hours, or 20 hours per new API.

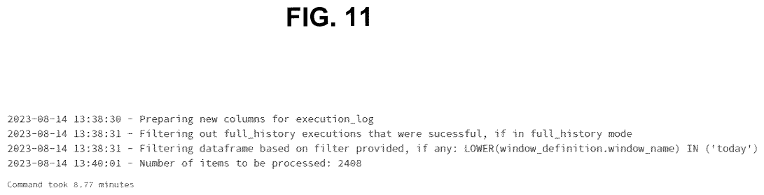

FIG. 11 shows a log for processing 2408 items in full_history mode in accordance with an embodiment of the data-gathering process of the present invention.

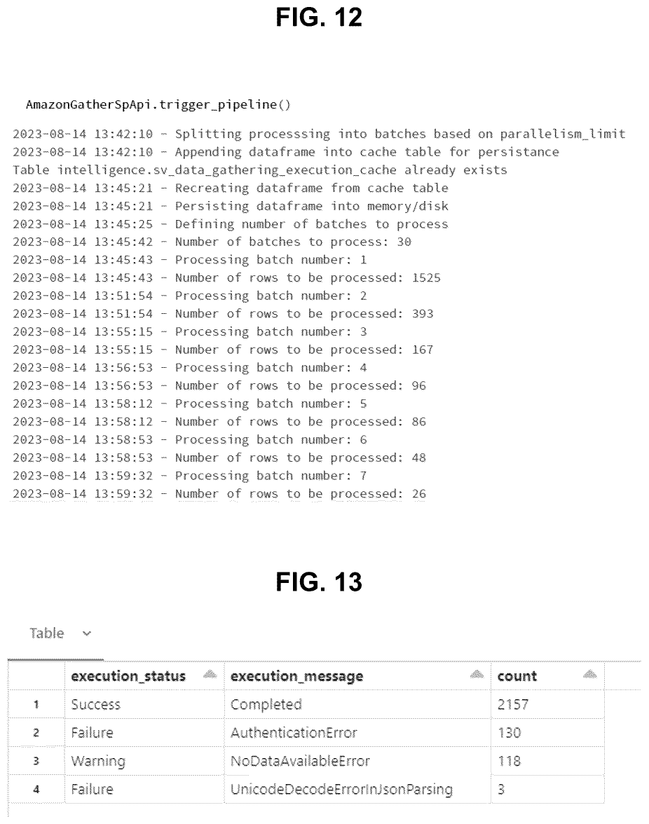

FIG. 12 shows the process of splitting data in batches to respect the parallelism limit of a given channel, e.g., AMAZON, in accordance with an embodiment of the data-gathering process of the present invention.

FIG. 13 shows the result of the data-gathering process of the 2,408 items detailed in the log of FIG. 11. The results shown include: the number of successful retrieved values; the number of failed retrieved values due to authentication errors; the number of failed retrieved values due to unavailable data, which is represented as a warning in the data-gathering process of the present invention and not necessarily an error or failure; and the number of failed gathering attempts due to parsing.

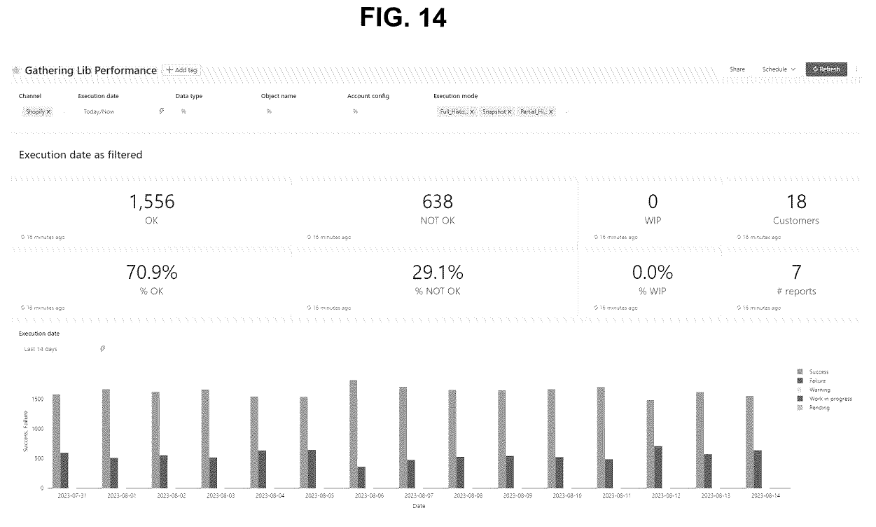

FIG. 14, in accordance with an embodiment of the present invention, shows an exemplary dashboard generated by the Framework after completing the retrieval process of the data on a given channel, such as SHOPIFY. The retrieved data are split into the desired categories, e.g., Full_History, Snapshot, and Partial_History. As can be seen in the exemplary dashboard shown in FIG. 14, the dashboard may show the percentage of successful data retrievals versus failed retrievals. In the example shown in FIG. 14, 70.9% of the retrieved data were OK and 29.1% failed. A bar chart may be shown in the dashboard, with the bar chart allowing for a quick reference to see if the ratio of failed to successful data retrievals is consistent with previous data retrievals. In the example of FIG. 14, it can be seen that the ratio of failed to successful data retrievals is consistent.

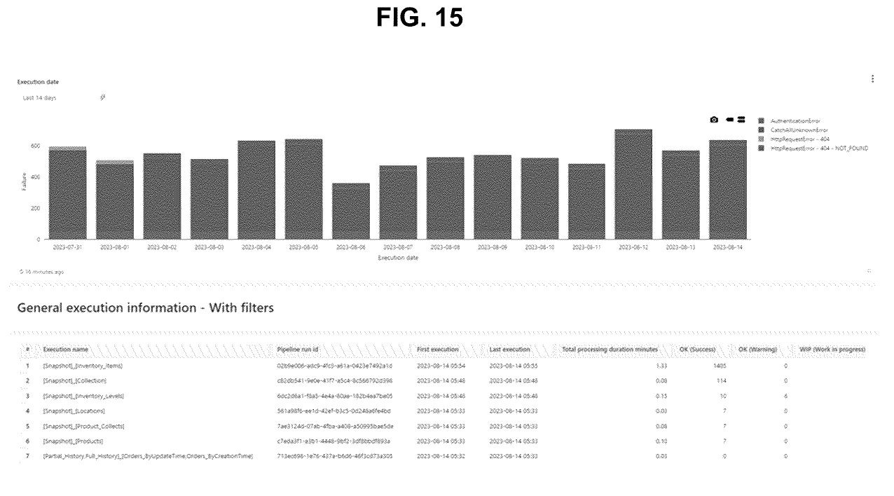

FIG. 15 shows a graphical and tabular quantification of errors according to an exemplary data classification of the results of a data retrieval process in accordance with an embodiment of the present invention. As can be seen, the majority of errors fall into the category of unknown errors.

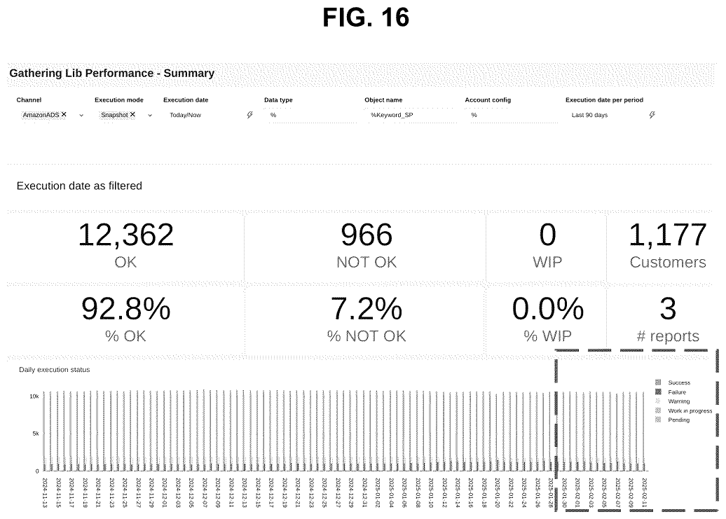

FIG. 16 shows a summary for a specific day, Feb. 11, 2025 (2025-2-11), which also correlates with the last day represented in the graph located at the bottom of the figure. For this specific day, there were 13,328 attempts made to retrieve data from 1,177 clients, for which 12,362 attempts were successful (92.8%) and 966 were unsuccessful (7.2%). At the end of this day, 0 attempts were categorized as WIP (Work In Progress). The graph located at the bottom of the figure may serve to call attention to any anomalies occurring in connection with data retrieval for a particular day. For this specific day, the graph indicates no anomalies, i.e., no points of interest.

When compared with FIG. 14, which represents use of the same process employed in connection with FIG. 16 but for Aug. 14, 2023 (2023-08-14), the success ratio increased 30.8%, from 70.9% to 92.8%, which demonstrates a quantifiable improvement associated with the present invention. This critical decrease in the number of unsuccessful attempts, even in light of continuous modifications of the API rules by the marketplaces, is achieved through the ease in adapting the data retrieval process to the rules alteration introduced by the Framework, a cornerstone of the present invention.

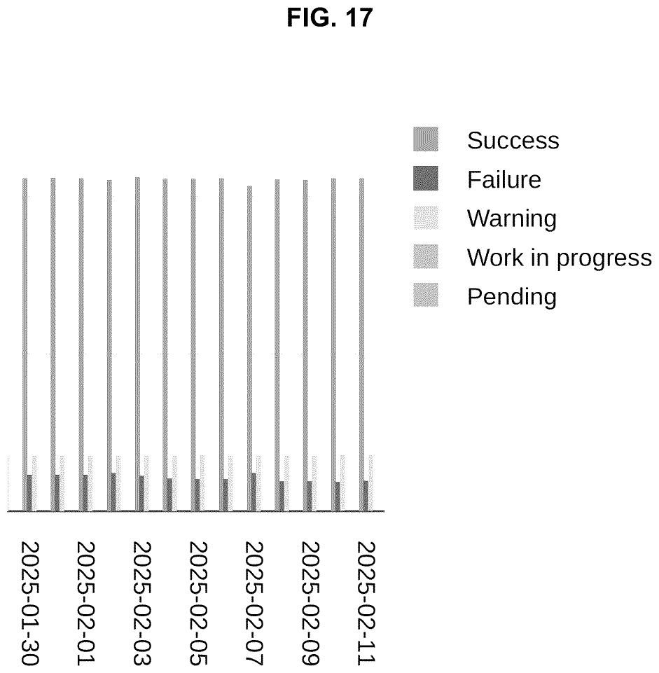

The area of the graph in FIG. 16 highlighted by the dashed square is depicted in FIG. 17. FIG. 17 shows explanatory captions employed in evaluating an effectiveness of the process of the present invention.

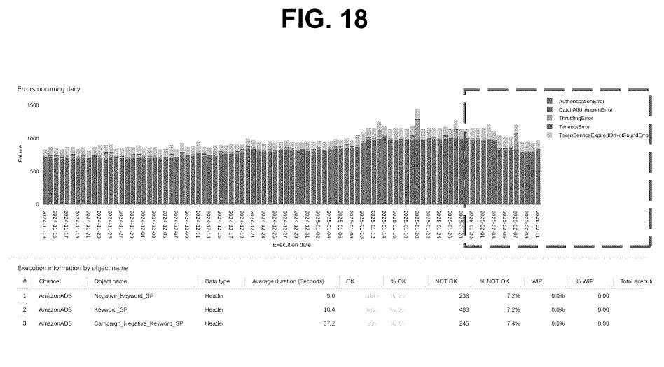

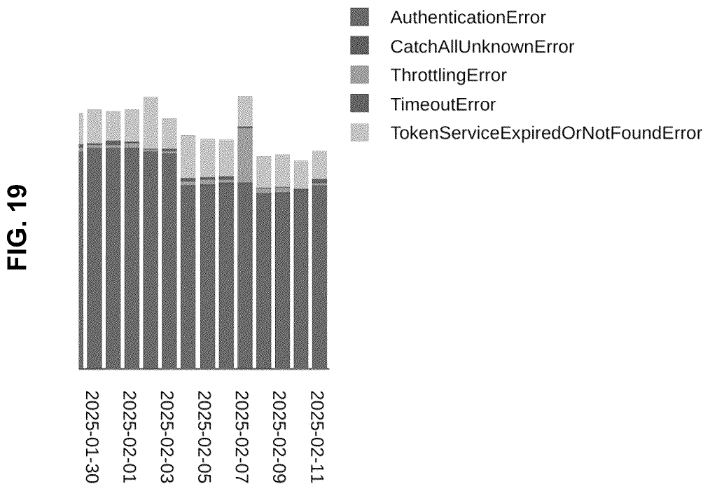

FIG. 18 shows a distribution of particular errors of note, namely authentication errors, unknown errors, throttling errors, token service expiration errors, and timeout errors. The graph of FIG. 18 shows that a large majority of these errors constitute authentication errors and token service expiration errors. The area of the graph in FIG. 18 highlighted by the dashed square is depicted in FIG. 19. FIG. 19 shows explanatory captions employed in categorizing errors attendant to the process of the present invention.

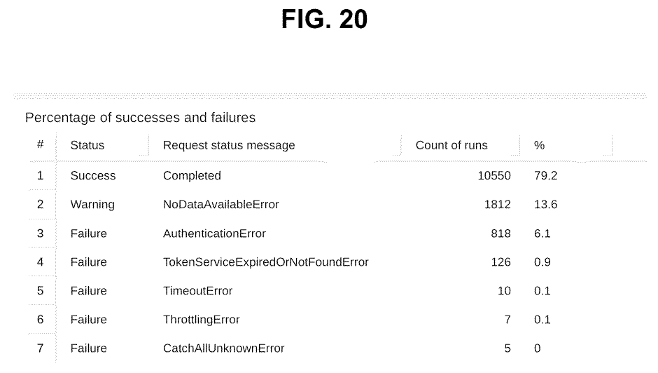

FIG. 20 shows an outlook of error percentages in a process of the present invention. Errors that could not be attributed to the present invention, reflected in lines 5, 6, and 7 and directed to timeout errors, throttling errors, and unknown errors respectively, amounts to only 0.2% of errors. All additional errors fall under a marketplace's responsibility, including data availability errors, authentication errors, and token service expiration errors.

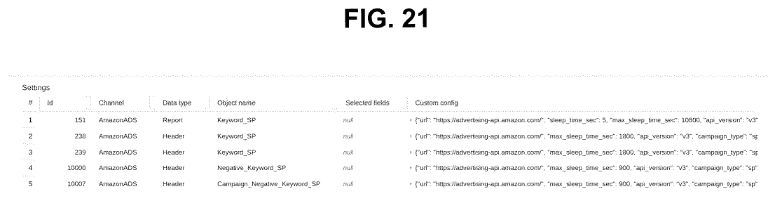

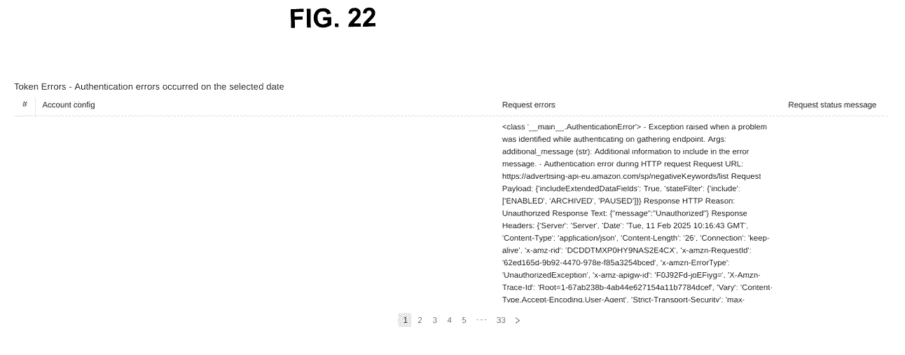

FIG. 21 shows a Framework configuration for each category of retrieved data. FIG. 22 shows an exemplary error message associated with a data retrieval process of the present invention.

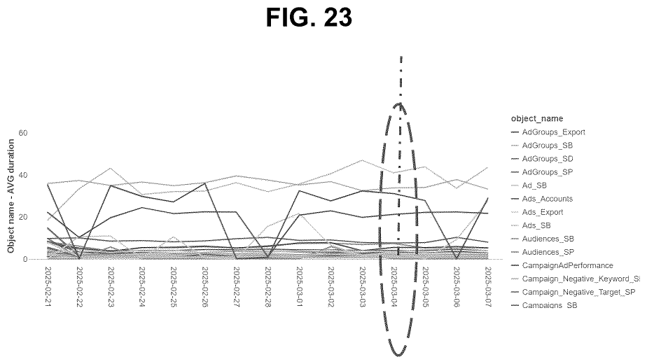

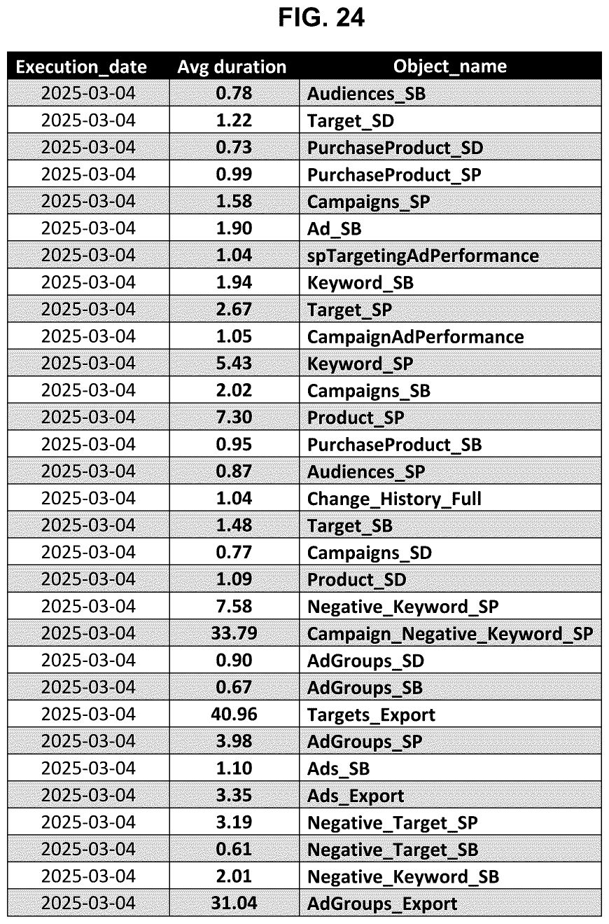

FIG. 23 shows a graph based on average duration, with timing reflected in seconds, for exemplary data retrieval processes in connection with a single marketplace. The graphical representation of the retrieved data for Mar. 4, 2025 (2025-03-04) is highlighted. FIG. 24 provides a recitation of those APIs used to retrieve data on Mar. 4, 2025 in connection with the processes associated with FIG. 23.

The embodiments and examples above are illustrative, and many variations can be introduced to them without departing from the spirit and scope of the disclosure or from the scope of the invention. For example, elements and/or features of different illustrative and exemplary embodiments herein may be combined with each other and/or substituted with each other within the scope of this disclosure. For a better understanding of the invention, its operating advantages and the specific objects attained by its uses, reference should be had to the drawings and descriptive matter, in which there is illustrated a preferred embodiment of the invention.

What is claimed is:

1. A method for retrieving data associated with an online marketplace, comprising:
under control of one or more processors configured with executable instructions,
determining, based on a search of a configuration table, a configuration associated with an online marketplace channel API, the configuration table including one or more data fields for one or more online marketplace channel current or updated APIs;
determining, based on a search of a customer query table, one or more customers requiring data retrieval;
generating one or more required time periods for data retrieval based in part on one or more settings of the configuration associated with the online marketplace channel API;
dividing, based on the one or more settings of the configuration associated with the online marketplace channel API, the one or more required time periods into a plurality of time subperiods compliant with the online marketplace channel API;
retrieving data from the online marketplace channel API in batches based on the plurality of time subperiods compliant with the online marketplace channel API; and
storing the retrieved data.

2. The method of claim 1, wherein the one or more data fields for one or more online marketplace channel current or updated APIs are one or more of a channel name, a data ingestion call alias, a listing of all fields of data extracted from an online marketplace channel API endpoint, a local storage location, an SQL query listing of customers to be processed for data retrieval, a duration for data retrieval, and a data retrieval speed.

3. The method of claim 2, wherein the one or more data fields for one or more online marketplace channel current or updated APIs include a channel name, a data ingestion call alias, and a local storage location.

4. The method of claim 1, wherein generating one or more required time periods for data retrieval includes retrieving a full data history and a partial data history for establishing configuration settings.

5. The method of claim 4, wherein the configuration settings include a period name, a period start date, a period end date, and a number of dates between the period start date and the period end date.

6. The method of claim 1, further comprising storing an execution log of all data retrievals.

7. The method of claim 6, wherein the execution log includes metrics relating to all data retrievals, the metrics including one or more of a percentage of data retrieval successes, a percentage of data retrieval failures, a number of data retrieval executions, a percentage of errors, and a data retrieval duration.

8. The method of claim 7, wherein the errors in the percentage of errors include authentication errors, unknown errors, throttling errors, token service expiration errors, and timeout errors.

9. The method of claim 6, wherein the execution log is displayed on a single centralized dashboard.

10. The method of claim 1, wherein the retrieved data is stored in a local infrastructure of a digital marketing company.

11. A system for retrieving data associated with an online marketplace, comprising:
one or more processors;
one or more computer-readable media; and
one or more modules maintained on the one or more computer-readable media that, when executed by the one or more processors, cause the one or more processors to perform operations including:
determining, based on a search of a configuration table, a configuration associated with an online marketplace channel API, the configuration table including one or more data fields for one or more online marketplace channel current or updated APIs;
determining, based on a search of a customer query table, one or more customers requiring data retrieval;
generating one or more required time periods for data retrieval based in part on one or more settings of the configuration associated with the online marketplace channel API;
dividing, based on the one or more settings of the configuration associated with the online marketplace channel API, the one or more required time periods into a plurality of time subperiods compliant with the online marketplace channel API;
retrieving data from the online marketplace channel API in batches based on the plurality of time subperiods compliant with the online marketplace channel API; and
storing the retrieved data.

12. The system of claim 11, wherein the one or more data fields for one or more online marketplace channel current or updated APIs are one or more of a channel name, a data ingestion call alias, a listing of all fields of data extracted from an online marketplace channel API endpoint, a local storage location, an SQL query listing of customers to be processed for data retrieval, a duration for data retrieval, and a data retrieval speed.

13. The system of claim 12, wherein the one or more data fields for one or more online marketplace channel current or updated APIs include a channel name, a data ingestion call alias, and a local storage location.

14. The system of claim 11, wherein generating one or more required time periods for data retrieval includes retrieving a full data history and a partial data history for establishing configuration settings.

15. The system of claim 14, wherein the configuration settings include a period name, a period start date, a period end date, and a number of dates between the period start date and the period end date.

16. The system of claim 11, further comprising an additional operation of:
storing an execution log of all data retrievals.

17. The system of claim 16, wherein the execution log includes metrics relating to all data retrievals, the metrics including one or more of a percentage of data retrieval successes, a percentage of data retrieval failures, a number of data retrieval executions, a percentage of errors, and a data retrieval duration.

18. The system of claim 17, wherein the errors in the percentage of errors include authentication errors, unknown errors, throttling errors, token service expiration errors, and timeout errors.

19. The system of claim 16, wherein the execution log is displayed on a single centralized dashboard.

20. The system of claim 11, wherein the retrieved data is stored in a local infrastructure of a digital marketing company.
